(19) United States
(12) Patent Application Publication
(10) Pub. No.: US 2010/0145985 A1
(43) Pub. Date: Jun. 10, 2010

(54) DOCUMENT MANAGEMENT APPARATUS, METHOD, AND PROGRAM

(75) Inventor: Masanari Takahashi, Chiba (JP)

Correspondence Address: CANTOR COLBURN, LLP, 20 Church Street, 22nd Floor, Hartford, CT, 06103, US

(73) Assignee: TOYO ENGINEERING CORPORATION, Tokyo (JP)

(21) Appl. No.: 12/664,780

(22) PCT Filed: Jun. 13, 2008
(86) PCT No.: PCT/JP2008/001538

§ 371 Date: Dec. 15, 2009

(30) Foreign Application Priority Data
Jun. 15, 2007 (JP) 2007-158239

(51) Int. Cl. G06F 17/30

(52) U.S. Cl. 707/769; 707/E17.008; 707/781; 707/E17.005; 707/E17.014

(57) ABSTRACT

A document management device (100) comprises a document information storage unit (114) for storing document information including at least one keyword associated with a document so as to search for the document, a sectoral keyword list storage unit (122) for storing a sectoral keyword option list containing a technical keyword relating to each of sections, a common keyword list storage unit (120) for storing a common keyword option list containing a general keyword common to the sections, an authenticating unit (108) for authenticating the login by the user into a section, a presenting unit (128) for displaying the sectoral keyword option list of the section and the common keyword option list on a screen, a keyword receiving unit (130) for receiving the in keyword selected from the sectoral or common keyword option list, a searching unit (132) for searching the document information storage unit (114) by using the received keyword, and a presenting unit (128) for presenting the search result to the user.

### TECHNICAL FIELD

The present invention relates to a technique of electronically storing and managing document information.

### BACKGROUND ART

In a company, if so-called knowledge such as documents and information accompanying high technologies, wealth of knowledge, and experience stored in long years remains as know-how of an individual employee, there is a possibility that the knowledge is lost at an occasion such as resignation of the employee. It is a big issue for a company how to share the knowledge among employees and pass it to the next generation.

In recent years, a trend of computerizing documents such as various reports and technical data in an organization such as a company, which are managed in paper is becoming mainstream. In such a trend, an information management apparatus for efficiently forming a database by organizing an enormous amount of document information in different formats and capable of handling also document information which is updated daily is in demand.

Conventionally, a method of giving a keyword of a hierarchical structure at the time of registering document information is known. When the user of a database registers document information, the user retrieves a proper keyword from a keyword group having a hierarchical structure of large classification, intermediate classification, and small classification and gives it.

In a case of the hierarchical structured keyword, to retrieve a proper keyword when the user registers document information, the user designates a keyword in the hierarchical structure of large classification, intermediate classification, and small classification. Consequently, the user has to expand the hierarchical structure and display it. A work of sequentially expanding the hierarchical structure and allocating a keyword is troublesome and is inconvenient for use. Therefore, at the time of allocating a keyword to new document information, most of users who register document information feel enough only after registering a few keywords which are found by chance. Due to this, related keywords are not completely allocated to all of the document information. Consequently, when the user performs a keyword search at the time of retrieving document information, the user often cannot reach desired document information. As described above, with a normal hierarchical-structure keyword, desired document information cannot be retrieved and, moreover, registration is a burden on the user, so that the user does not perform the work of allocating a keyword to new document information or does not perform sufficient allocation. As a result, document information which is registered with an effort cannot be sufficiently retrieved.

In the work of retrieving document information from the hierarchical structure, if the user does not understand the configuration policy of the hierarchy itself and the concept of the classification, it is difficult to trace the hierarchy with confidence. Further, there is also a case that, at the time point when the user finds that he/she traced a wrong branch, the user cannot determine the place to return. On the other hand, as the academic systems, technical systems, and work operations are becoming complicated, it is becoming difficult to trace the hierarchy also for an expert and a skilled person who know the background to a certain degree.

To solve such problems in the hierarchical structure keywords, there is an apparatus, described in patent document 1, for searching document information by accepting a search keyword using a keyword option list screen which varies according to a viewpoint which varies. In the apparatus described in the patent document 1, in the keyword option list screen, about 150 keywords can be displayed at the maximum on a screen. The keyword option list can be prepared by, for example, classifying keywords in groups each having the same sense of value or by work operations. Since all of selectable keywords are displayed, a psychological burden on the user who performs registration like in a case of a database using the hierarchical structure keywords is lessened, so that the keyword allocation ratio improves. For example, in a case such that a part of keywords is hidden and cannot be displayed without scrolling, the probability of allocating a keyword which is not displayed at the time of registering document information is much lower than that in a case where a list of keywords is displayed and seen. As described above, it is very effective also from the viewpoint of the keyword allocation ratio to dispose and display all of keyword options in the keyword option list screen.

Since the document information registration and search can be performed by using the same screen, the user remembers the positions of keywords in an image, so that the keyword input load further decreases. Further, even users who do not understand the configuration policy and the concept of the classification such as young inexperienced operators having the same elemental technology can find out document information of an experienced operator via the keyword, and the document information can be shared.

An information management apparatus described in patent document 2 can classify document information with two different attributes, register it, and register the document information in association with keywords from different keyword option lists corresponding to the attributes. Therefore, document information can be retrieved by accepting search keywords using different keyword option list screens from different viewpoints. A document information search can be performed from various viewpoints and a search can be performed with a proper keyword.
Patent document 1: International publication WO/2004/081822
Patent document 2: International publication WO/2006/030485

### DISCLOSURE OF THE INVENTION

The conventional techniques described in the publications, however, have room to improve with respect to the following points.

In information management using the keyword option list screen as described above, in a case of information common to a plurality of sections, for example, in a case of retrieving necessary document information from a title and document information, a keyword search using “spreadsheet” and “trouble report” which can be used commonly among sections cannot be made in order to perform searches such as “data of spreadsheet presented to the section A” and “trouble report to be fed back to the section C in the work B”. In many cases, document information which is important to a user in a section is not always important to a user in another section. That is, in a case of performing a search, a mechanism for easily retrieving important document information which varies among works and among organizations from different document information search angles and retrieving no unnecessary information of other sections is in demand. On the other hand, the existence of knowledge to be shared among a plurality of sections is unignorable.

The present invention has been achieved in view of the above circumstances, and an object of the invention is to provide a document management apparatus, method, and program capable of improving efficiency of a keyword search on document information and realizing effective utilization of document information among sections.

According to the present invention, there is provided a document management apparatus including: a document information storage unit which stores document information including at least one keyword associated with a document so as to search for the document; a sectional keyword option storage unit which stores a plurality of sectional keyword option lists each containing a specialistic keyword relating to each of a plurality of sections; a common keyword option storage unit which stores a common keyword option list containing a general keyword common to the plurality of sections; an authentication unit which accepts selection of a section and entry of authentication information from a user and conducts login authentication to the section; a keyword option list display unit which reads the sectional keyword option list corresponding to the section authenticated by the authentication unit from the sectional keyword option storage unit, reads the common keyword option list from the common keyword option storage unit, and displays the sectional keyword option list and the common keyword option list on a single screen; a accepting unit which accepts a keyword selected by the user from the sectional keyword option list or the common keyword option list displayed on the keyword option list display unit; a searching unit which searches the document information storage unit based on the keyword accepted by the accepting unit; and a presenting unit which presents a result of the search made by the searching unit to the user.

According to the present invention, the keyword option list prepared for each of sections can be presented to a user who logged in a section designated by the user, and the user can select a keyword. sections are, for example, groups formed by organizations, works, or the like. Therefore, by providing keyword option lists by sections, document information can be retrieved with a more appropriate keyword which is specialistic and adapted to a section. Necessary document information can be retrieved more efficiently, so that the document search efficiency improves. In addition, a search condition can be set by using a proper keyword which is favorite to the user, so that usability and operability is high, an irrelevant search result due to erroneous selection of a keyword can be prevented, and the search efficiency improves. In a case where the user of another section having no specialistic knowledge retrieves document information, a search can be performed using a general common keyword. Therefore, it is very convenient.

The document management apparatus may further include: a document storing unit, for the purpose of associating the document information with any of the plurality of sections and further classifying it to a plurality of categories, which has a plurality of regions corresponding to combinations of the sections and the categories and stores the document in any of the regions; and a search target accepting unit which accepts any of said plurality of categories which is selected, by the user, as a search target for searching document information related to the selected category. The document information storage unit may further store the region in which the document is stored so as to be associated with the corresponding document information, and the searching unit narrows down to the region corresponding to the category of the search target accepted by the search target accepting unit and the section which the user has been authenticated, and searches within the narrowed region of the document information storage unit.

With the configuration, a search can be made by selecting a section and a category to be searched under narrowing conditions, so that the document search efficiency improves, and effective utilization of information can be realized.

In the document management apparatus, the authentication unit may accept authentication of login to all of the plurality of sections and authenticates the user, the search target accepting unit accepts at least one of the plurality of sections which is selected as a search target for searching document information related to the selected section, and the searching unit may narrow down to the region corresponding to the section and the category as the search target accepted by the search target accepting unit, and search within the narrowed region of the document information storage unit.

With the configuration, a search can be made by selecting a section and a category of a search target under narrowing conditions, so that unnecessary information can be prevented from being retrieved in vain, and the document search efficiency improves.

The document management apparatus may further include: a registration keyword option list display unit which displays the sectional keyword option list and the common keyword option list on a single screen in order to register a keyword associated as the document information of the document for the purpose of retrieving the document; and a registration accepting unit which accepts, as a keyword as document information to be associated with the document, a keyword selected by the user from the sectional keyword option list or the common keyword option list displayed on the keyword option list display unit. The accepted keyword may be stored as the document information so as to be associated with the document in the document information storage unit.

With the configuration, while browsing the general common keyword and the specialistic sectional keyword on a single screen, both of the keywords can be given, so that operability is high. Therefore, a more narrowed search can be performed even by a user of another section and a user of a section of the user who registered the document information. Consequently, for example, in a case of information related to a plurality of sections, with respect to searches such as “data of spreadsheet presented to the section A” and “trouble report to be fed back to the section C in the work B”, by listing keywords such as “spreadsheet” and “trouble report” as common keywords, registration of keywords becomes easier, and document information can be retrieved.

According to the present invention, there is also provided a document managing method of electronically storing document information including at least one keyword associated with a document so as to search for the document into a document information storage unit and managing it, including: preparing a document information storage unit which stores the document information; preparing a sectional keyword option storage unit which stores a plurality of sectional keyword option lists each containing a specialistic keyword relating to each of a plurality of sections; preparing a common keyword option storage unit which stores a common keyword option list containing a general keyword common to the plurality of sections; accepting selection of a section and entry of authentication information from the user and conducting login authentication to the section; reading the sectional keyword option list corresponding to the authenticated section from the sectional keyword option storage unit, reading the common keyword option list from the common keyword option storage unit, and displaying the sectional keyword option list and the common keyword option list on a single screen; accepting a keyword selected by the user from the sectional keyword option list or the common keyword option list displayed; searching the document information storage unit based on the accepted keyword; and presenting a result of the search to the user.

According to the present invention, there is also provided a document management program for controlling a computer that electronically stores document information including at least one keyword associated with a document so as to search for the document into a document information database and manages it. The computer includes: a document information database in which the document information is stored; a sectional keyword option storage unit which stores a plurality of sectional keyword option lists each containing a specialistic keyword relating to each of a plurality of sections; and a common keyword option storage unit which stores a common keyword option list containing a general keyword common to the plurality of sections. The program makes the computer execute: a procedure of accepting selection of a section and entry of authentication information from a user and conducting login authentication to the section; a procedure of reading the sectional keyword option list corresponding to the authenticated section from the sectional keyword option storage unit, reading the common keyword option list from the common keyword option storage unit, and displaying the sectional keyword option list and the common keyword option list on a single screen; a procedure of accepting a keyword selected by the user from the sectional keyword option list or the common keyword option list displayed; a procedure of searching the document information database based on the keyword accepted; and a procedure of presenting a result of the search to the user.

It is to be noted that any desired combination of the foregoing constituents, and any conversion of the expressions in the present invention among methods, equipments, systems, recording media, or computer programs is effectively included in the scope of the present invention.

According to the present invention, the document management apparatus, method, and program capable of improving the efficiency of retrieving document information with a keyword and realizing effective utilization of information can be provided.

### BRIEF DESCRIPTION OF THE DRAWINGS

The foregoing objects and the other objects, features, and advantages will be more apparent from an exemplary embodiment to be described below and accompanying drawings.

FIG. 1 is a functional block diagram showing the configuration of a document management system according to an embodiment of the present invention.

FIG. 2 is a diagram showing an example of the structure of a document storing unit in the document management system of FIG. 1.

FIG. 3 is a diagram showing an example of the structure of an authentication information storage unit in a document management apparatus in FIG. 1.

FIG. 4 is a diagram showing an example of the structure of an access right storage unit in the document management apparatus in FIG. 1.

FIG. 5 is a diagram showing an example of the structure of a document information storage unit in the document management apparatus in FIG. 1.

FIG. 6 is a diagram showing an example of a keyword list display screen in the document management apparatus in FIG. 1.

FIG. 7 is a diagram showing an example of a login screen in the document management apparatus in FIG. 1.

FIG. 8 is a diagram showing an example of a category selection screen in the document management apparatus in FIG. 1.

FIG. 9 is a diagram showing an example of a search result screen of the document management apparatus in FIG. 1.

FIG. 10 is a diagram showing an example of a document information screen in the document management apparatus in FIG. 1.

FIG. 11 is a diagram showing an example of a general search screen in the document management apparatus in FIG. 1.

FIG. 12 is a diagram showing an example of a database selection screen in the document management apparatus in FIG. 1.

FIG. 13 is a diagram showing an example of a keyword search screen in the document management apparatus in FIG. 1.

FIG. 14 is a flowchart showing an example of the operation of the document management apparatus in FIG. 1.

FIG. 15 is a flowchart showing continuation of the flowchart of FIG. 14.

FIG. 16 is a diagram showing an example of a document management screen in the document management apparatus in FIG. 1.

### BEST MODE FOR CARRYING OUT THE INVENTION

Embodiments of the present invention will be described below with reference to the drawings. Throughout the entire drawings, the same constitutional elements refer to the same reference numerals, and the detailed descriptions will be not shown.

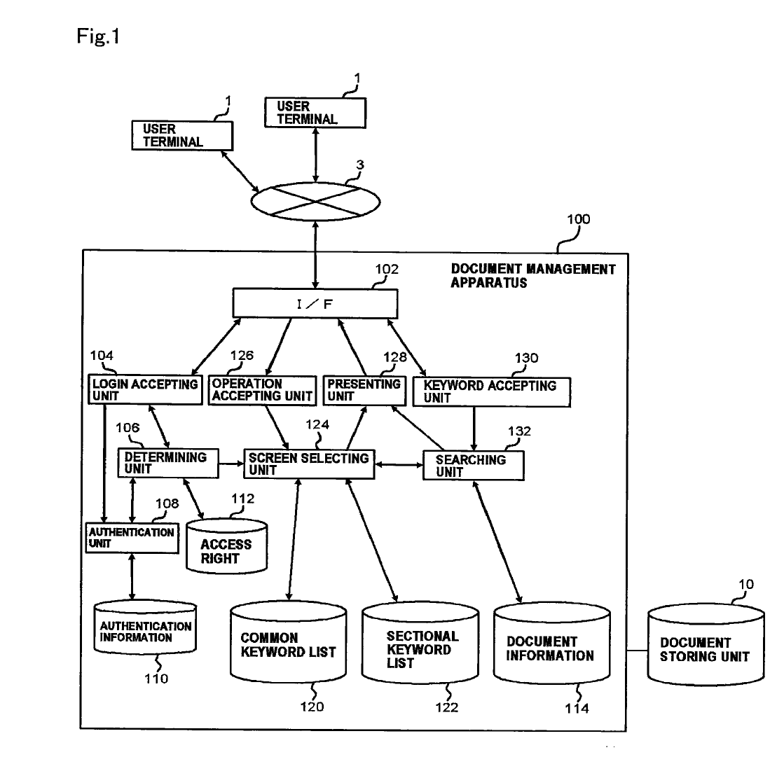

FIG. 1 is a functional block diagram showing the configuration of a document management system according to an embodiment of the present invention. A document management apparatus 100 of this embodiment has: a document information storage unit 114 which stores document information including at least one keyword associated with a document so as to search for the document; a sectional keyword option storage unit (sectional keyword list storage unit 122) which stores a plurality of sectional keyword option lists each containing a specialistic keyword relating to each of a plurality of sections; a common keyword option storage unit (common keyword list storage unit 120) which stores a common keyword option list containing a general keyword common to the plurality of sections; an authentication unit 108 which accepts selection of a section and entry of authentication information from a user and conducts login authentication to the section; a keyword option list display unit (screen selecting unit 124 and a presenting unit 128) which reads the sectional keyword option list corresponding to the section authenticated by the authentication unit 108 from the sectional keyword option storage unit (the sectional keyword list storage unit 122), reads the common keyword option list from the common keyword option storage unit (common keyword list storage unit 120), and displays the sectional keyword option list and the common keyword option list on a single screen; a accepting unit (keyword accepting unit 130) which accepts a keyword selected by the user from the sectional keyword option list or the common keyword option list displayed on the keyword option list display unit (presenting unit 128); a searching unit 132 which searches the document information storage unit 114 based on the keyword accepted by the accepting unit (keyword accepting unit 130), and the presenting unit 128 which presents a result of the search performed by the searching unit 132.

The document management apparatus 100 is, for example, a personal computer (PC), a workstation, an office computer, or the like connected to a network 3 such as a LAN (Local Area Network), a WAN (Wide Area Network), or the like. The document management apparatus 100 includes a control unit (central processing unit (CPU)), a memory, a display unit, and an operation unit which are not shown in the drawings. In the drawings described below, the configuration of each of parts which are not related to the essence of the present invention will not be described.

Each constitutional element of the document management apparatus 101 is realized by any combination of hardware and software based on a CPU of any computer, a memory, a program that is loaded on the memory to implement the components shown in the drawings, a memory unit such as a hard disk that stores the program, and an interface for network connection. It will be understood by those skilled in the art that a diversity of variations of a method and device of realizing the components may be made. Each of drawings to be described hereinafter does not depict hardware-based constructions but function-based blocks.

The document management apparatus 100 of this embodiment is realized when the CPU executes the document management program stored in the memory. The document management program controls a computer (the document management apparatus 100) that electronically stores document information into a document information database (the document information storage unit 114) which stores document information including at least one keyword associated with a document so as to retrieve the document and manages it. The computer (the document management apparatus 100) includes: a document information database (the document information storage unit 114) in which the document information including a keyword associated with a document so as to retrieve the document is stored; a sectional keyword option storage unit (the sectional keyword list storage unit 122) which stores a plurality of sectional keyword option lists each containing a specialistic keyword relating to each of a plurality of sections; and a common keyword option storage unit (the common keyword list storage unit 120) which stores a common keyword option list containing a general keyword common to the plurality of sections. The program makes the computer (the document management apparatus 100) execute: a procedure (the authentication unit 108) of accepting selection of a section and entry of authentication information from a user and conducting login authentication to the section; a procedure (the screen selecting unit 124 and the presenting unit 128) of reading the sectional keyword option list corresponding to the authenticated section from the sectional keyword option storage unit (the sectional keyword list storage unit 122), reading the common keyword option list from the common keyword option storage unit (the common keyword list storage unit 120), and displaying the sectional keyword option list and the common keyword option list on a single screen; a procedure (the keyword accepting unit 130) of accepting a keyword selected by the user from the sectional keyword option list or the common keyword option list displayed; a procedure (the searching unit 132) of searching the document information database (the document information storage unit 114) based on the keyword accepted; and a procedure (the presenting unit 128) of presenting a result of the search to the user.

The document management apparatus 100 is connected to a plurality of user terminals 1 by wire or wirelessly. In a document storing unit 10, a document relating to document information managed by the document management apparatus 100 is stored. For example, the document storing unit 10 is a hard disk drive, various recording media, and a device for reading the media. Although one document storing unit 10 is provided for one document information storage unit 114 in FIG. 1, a plurality of document storing units 10 may be provided. The document storing unit 10 may be connected to the document management apparatus 100 directly or wirelessly via a network or a serial or parallel cable.

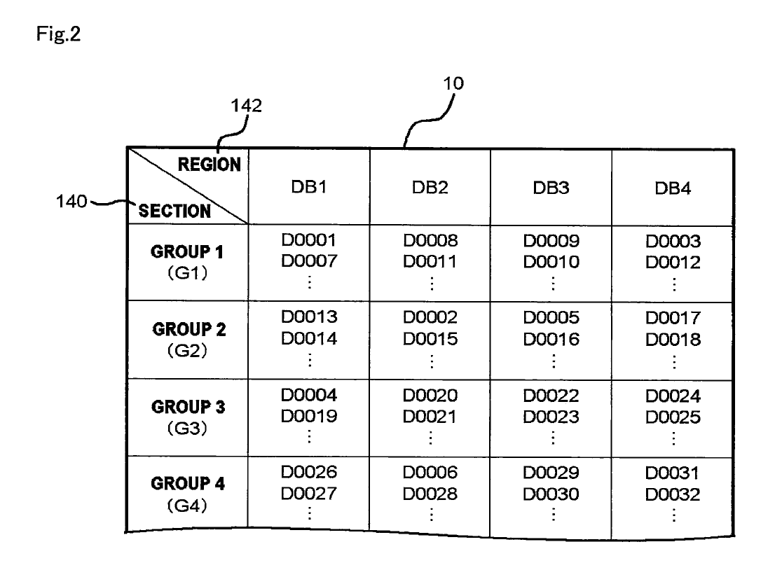

FIG. 2 is a diagram showing an example of the structure of the document storing unit 10 of this embodiment. The document management apparatus 100 has the document storing unit 10, for the purpose of associating a document with any of a plurality of sections 140 and further classifying it to a plurality of categories, having a plurality of regions 142 corresponding to combinations of the sections 140 and the categories and storing a document in any of the regions 142.

Concretely, the document storing unit 10 has the plurality of regions 142 corresponding to the plurality of sections 140, and document information of one document is stored in one region. For example, in a region DB1 of group 1 (G1), documents respective having document IDs D0001, D0007, and the like are stored. In this embodiment, the “document” includes a document file created by a word processor, a spreadsheet file created by spreadsheet software, a file created by presentation software, a PDF (Portable Document Format) file, various image files, various text files, an image file, a sound file, a video file, a mail, various program files, various data files, and various information accompanying a document. Each document is provided with a document ID and is managed.

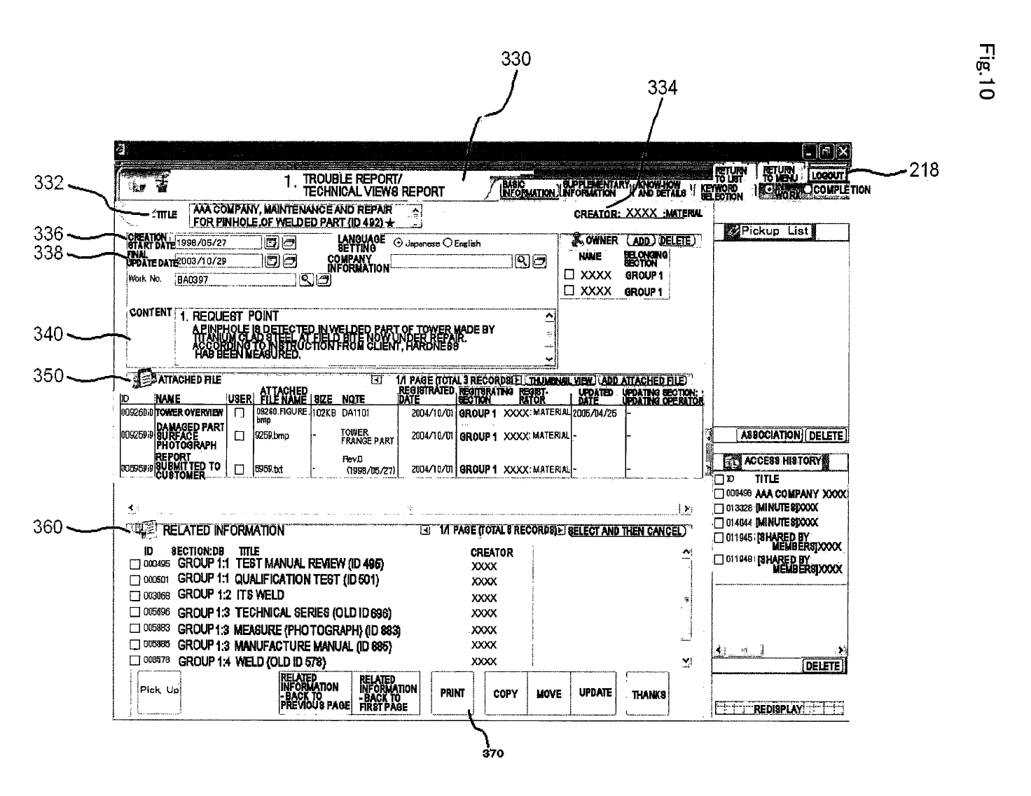

The document information includes not only a keyword but also various information such as various information to be referred to on a document information screen 330 shown in FIG. 10. As an example, the document information may include the title of the document, a creator, creation start date, last update date, creation language, company information, an owner, a work number, content, attached file information, and related information. Further, the attached file information includes document ID, name, presence/absence of a user, filename, size, remarks, registration date, a registrant, a section to which the registrant belongs, update date, an updating person, and a section to which the updating person belongs of the attached file. The related information includes information ID, registered section and region, title, and creator.

The sections 140 are, for example, groups divided by organizations, works, or the like. As an example, the sections 140 may be divided by divisions, sections, project groups, or the like. The region 142, for example, region DB1 may be a region for storing a document related to a daily document creation work. The document includes, for example, business documents, proposals, obtained information, and the like. Region DB2 may be a region for storing a document related to information peculiar to the group. As an example, the document includes members' schedule, management documents, money information, a list of sales, experiences and know-how obtained with efforts, convenient tools, and the like. Region DB3 may be a region for storing documents of work standards, guides, formats, and the like. As an example, it includes formal work procedures, guides, manuals, contract sheets, work formats, and the like. Region DB4 maybe a region for storing documents of knowledge, questions and answers, and the like. As an example, it can include information of questions and answers on system introduction and maintenance, and the like.

Referring again to FIG. 1, the user terminal 1 is a terminal which is connected to the document management apparatus 100 via the network 3 by wire or wirelessly, and the user uses a document in the document storing unit 10 managed by the document management apparatus 100. The user terminal 1 is, for example, a PC, a workstation, an office computer, or the like. The user terminal 1 includes a control unit, a storage unit, a display unit, an operation unit, and an interface unit which are not shown in the drawings.

In the user terminal 1, the control unit controls each of the constitutional elements of the user terminal 1 and also the entire user terminal 1. The storage unit includes a hard disk drive that stores a program, a main memory having a region temporarily storing a program read from the hard disk drive and used at the time of executing the program, and external memories such as a floppy (registered trademark) disk, an MO, a CD-R (RW), a DVD-R (RW), and a magnetic tape. The display unit displays various information, an operation screen, an operation and a state of an apparatus, and the like and is, for example, a CRT monitor, a liquid crystal display, a plasma display, an organic EL (ElectroLuminescence) display, or the like.

The operation unit is operated by the user to make various settings and instruct an entry and is, for example, a keyboard, a mouse, a tablet, an operation button, a switch, a lever, a touch panel, and the like. By connecting the user terminal 1 and the document management apparatus 100 to each other via the network 3, various screens for managing a document can be displayed from the document management apparatus 100 on the display unit of the user terminal 1, a screen may be operated by using the operation unit of the user terminal 1, and an operation instruction can be given from the user terminal 1 to the document management apparatus 100. The interface unit performs communication with the document management apparatus 100 connected via the network 3.

The document management apparatus 100 has an interface unit (I/F) 102, a login accepting unit 104, a determining unit 106, an authentication unit 108, an authentication information storage unit (in the drawings, expressed as “authentication information”) 110, an access right storage unit (in the drawings, expressed as “access right”) 112, a document information storage unit (in the drawings, expressed as “document information” 114, a common keyword list storage unit (in the drawings, expressed as “common keyword list”) 120, a sectional keyword list storage unit (in the drawings, expressed as “sectional keyword list”) 122, a screen selecting unit 124, an operation accepting unit 126, a presenting unit 128, a keyword accepting unit 130, and a searching unit 132.

The interface unit 102 performs communication with the user terminal 1 via the network 3. Furthermore, the interface unit 102 provides a user interface to the user terminal 1. For example, the user terminal 1 has a browser function and can access the document management apparatus 100 and perform operation by using various operation screens provided by the document management apparatus 100.

The login accepting unit 104 accepts a login request from the user terminal 1. The user may select one section having document information desired to be retrieved and browsed from the plurality of sections, and instruct login to the selected section in a login screen which will be described later. The user may also select search and browse of all of document information without designating a section, and instruct login.

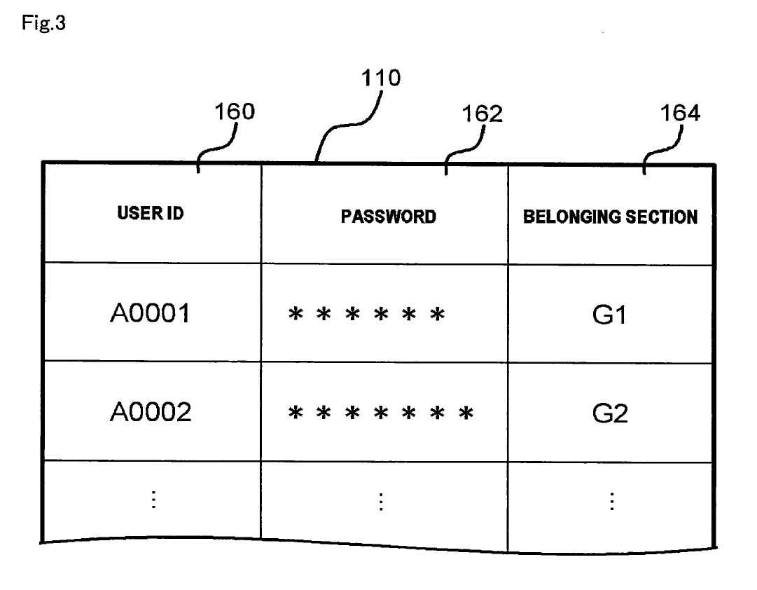

The authentication information storage unit 110 stores authentication information of each of users using the document management apparatus 100. FIG. 3 shows an example of the structure of the authentication information storage unit 110 of this embodiment. The authentication information storage unit 110 includes user ID 160, password 162, and a belonging section 164 of the user.

The determining unit 106 determines whether a login designating a section or a login to the whole is made and notifies the result of determination to the screen selecting unit 124. Further, the determining unit 106 accesses the authentication information storage unit 110, obtains the section of the user whose login is accepted, also accesses the access right storage unit 112, and checks access restriction to the section designated by the user.

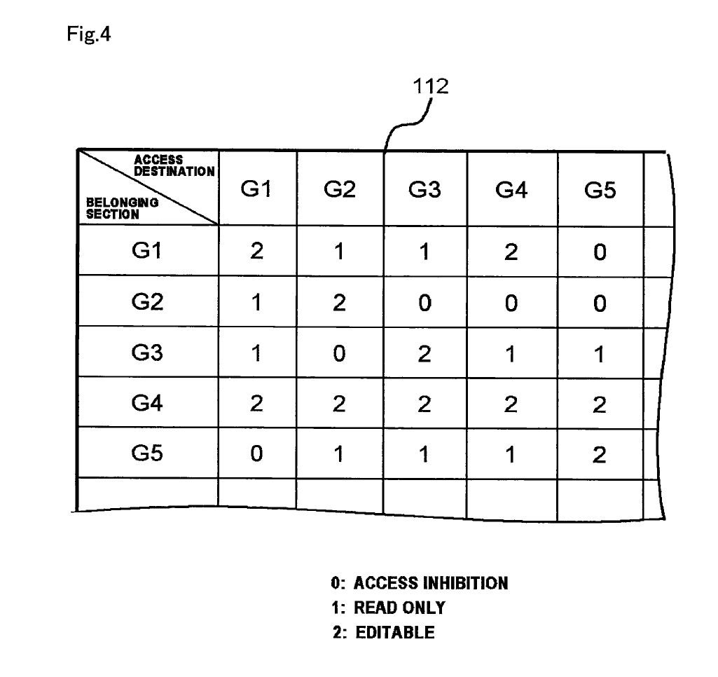

The access right storage unit 112 stores information of access restrictions among the sections of the users. FIG. 4 shows an example of the structure of the access right storage unit 112 of this embodiment. In the access right storage unit 112, access restriction to a document of a section to be accessed is registered by each section. For example, access restriction of “0” denotes inhibition of an access to a document and means that the existence itself of the document is not disclosed. Access restriction of “1” indicates that a document is handled as a document only to be read and edition of the document is inhibited. Access restriction of “2” indicates that a document can be even edited. For example, in the example of FIG. 4, the user of the section G1 can browse documents of the sections G2 and G3 but is inhibited to edit the documents, and the document of the section G5 is not disclosed to the user of the section G1. The user of the section G1 can browse and edit documents of the sections G1 and G4.

In this embodiment, the access restriction is set group by group. However, the invention is not limited to the configuration. The access restriction may be set in various modes like by databases of the groups, by users, by posts, and with deadlines.

Referring again to FIG. 1, the determining unit 106 refers to the access right storage unit 112 and checks the access restriction to the section accepted by the login accepting unit 104, which is the section to which the user belongs. In a case where the access restriction is “0”, the screen selecting unit 124 is instructed to display, to the user terminal 1, a message of notifying the user of the result that the document of the section cannot be referred to. In a case where the access restriction is “1” or “2”, the screen selecting unit 124 is instructed to display, to the user terminal 1, the keyword search screen of the corresponding section. Since control on whether a document can be edited or not according to the access restriction is not related to the essence of the present invention, its detailed description will not be given here.

The authentication unit 108 accepts a user ID and a password of the user from the determining unit 106 and authorizes the user ID and the password with reference to the authentication information storage unit 110.

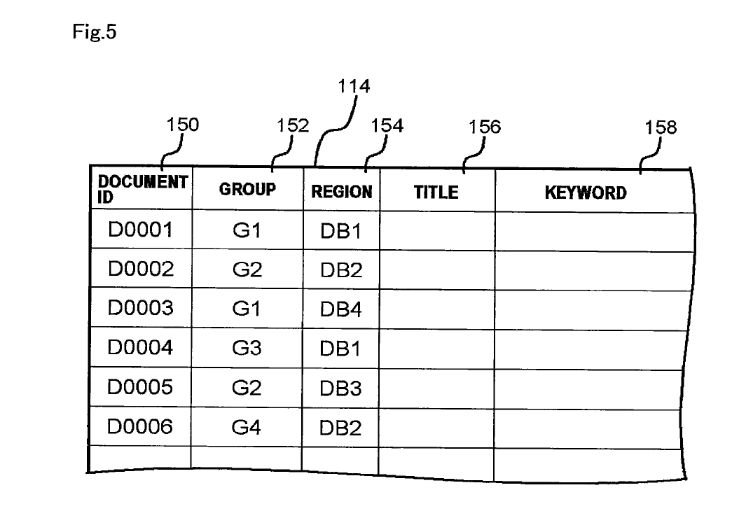

The document information storage unit 114 stores document information including a keyword associated with a document so as to retrieve the document. FIG. 5 is a diagram showing an example of the structure of the document information storage unit 114 of this embodiment.

The document information storage unit 114 includes a document ID 150 designated to each document, a group 152 to which the document belongs, a region 154, a title 156 of the document, and at least one keyword 158 associated with the document. The document information storage unit 114 may also include the above-described various document information. In this embodiment, the keyword 158 includes a general keyword common to a plurality of sections and a specialistic keyword peculiar to each section.

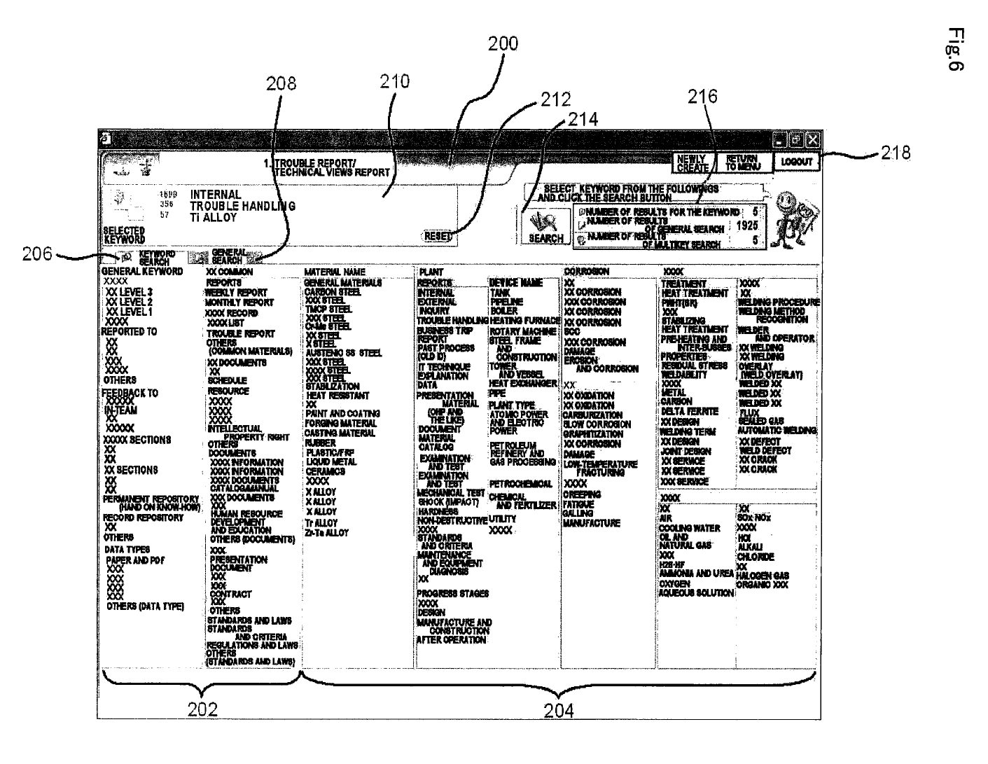

The common keyword list storage unit 120 stores a common keyword option list including a general keyword common to a plurality of sections. The sectional keyword list storage unit 122 stores a plurality of sectional keyword option lists each including a specialistic keyword related to each of the plurality of sections. FIG. 6 shows an example of a keyword list display screen 200 of this embodiment. As shown in the keyword list display screen 200, in a common keyword list display field 202, the common keyword option list stored in the common keyword list storage unit 120 is displayed. In a sectional keyword list display field 204, the sectional keyword option list stored in the sectional keyword list storage unit 122 is displayed.

In this embodiment, the document management apparatus may further include: a registration keyword option list display unit (not shown in the drawings) which displays the sectional keyword option list and the common keyword option list on a single screen in order to register a keyword to be associated as document information with the document for the purpose of retrieving the document; and a registration accepting unit (not shown in the drawings) which accepts, as a keyword which is included in document information to be associated with the document, a keyword selected by the user from the sectional keyword option list or the common keyword option list displayed on the keyword option list display unit. The accepted keyword may be stored as the document information so as to be associated with the document in the document information storage unit 114.

In this embodiment, as the keyword option list used at the time of associating a keyword with a document and the keyword option list used at the time of selecting a keyword to be used for retrieving the document information, the same list may be used. Consequently, while browsing the general common keyword and the specialistic sectional keyword on a single screen, both of the keywords can be given, so that operability is high. In addition, the specialistic keyword by section can be given as one piece of document information and used for a search, so that an exact keyword can be given and an accurate search can be realized. For example, in a case of information related to a plurality of sections, with respect to searches such as “data of spreadsheet presented to the section A” and “trouble report to be fed back to the section C in the work B”, by listing keywords such as “spreadsheet” and “trouble report” as common keywords, registration of keywords becomes easier, and document information can be retrieved.

As shown in FIG. 6, the keyword list display screen 200 further includes a keyword search tab 206, a general search tab 208, a selection keyword display field 210, a reset button 212, a search execution button 214, a search result display field 216, and a logout button 218. In a case where the keyword search tab 206 is selected, the keyword list display screen 200 of FIG. 6 is displayed, and a keyword may be selected from two keyword option lists. In the sectional keyword list display field 204, a keyword option list peculiar to a section in which the user logged is displayed. In a case where the general search tab 208 is selected, a general search screen which will be described later is displayed, and document information may be retrieved with an item other than the keyword.

In the selection keyword display field 210, a keyword selected from the keyword option list in the common keyword list display field 202 or the sectional keyword list display field 204 is displayed. The reset button 212 accepts an instruction of resetting all of keywords which were once selected and displayed on the selection keyword display field 210. The search execution button 214 accepts an instruction of executing a search for document information by using a keyword selected in the selection keyword display field 210. In the search result display field 216, for example, the number of document information pieces obtained as a result of each of the keyword search, the general search, and the search of the combination is displayed. The logout button 218 accepts an instruction of logout.

Referring again to FIG. 1, according to an instruction from the determining unit 106, the screen selecting unit 124 selects a screen to be presented to the user terminal 1 and gives an instruction to the presenting unit 128. For example, the screen selecting unit 124 accepts a section in which user logged from the determining unit 106, reads the sectional keyword option list of the section from the sectional keyword list storage unit 122, and passes it to the presenting unit 128.

The operation accepting unit 126 accepts various operations from the user terminal 1. For example, it accepts an operation on the search execution button 214 in the keyword list display screen 200 of FIG. 6. The presenting unit 128 provides various screens to the user terminal 1 via the interface unit 102.

The keyword accepting unit 130 accepts the keyword selected on the keyword list display screen 200 of FIG. 6 from the user terminal 1 and notifies the searching unit 132 of the keyword(s). Using the keyword(s) accepted by the keyword accepting unit 130, the searching unit 132 accesses the document information storage unit 114 in response to the acceptance of the operation on the search execution button 214 by the operation accepting unit 126, and retrieves document information. A result of the search is notified to the presenting unit 128 and the number of information pieces is displayed in the search result display field 216 in the keyword list display screen 200 of FIG. 6.

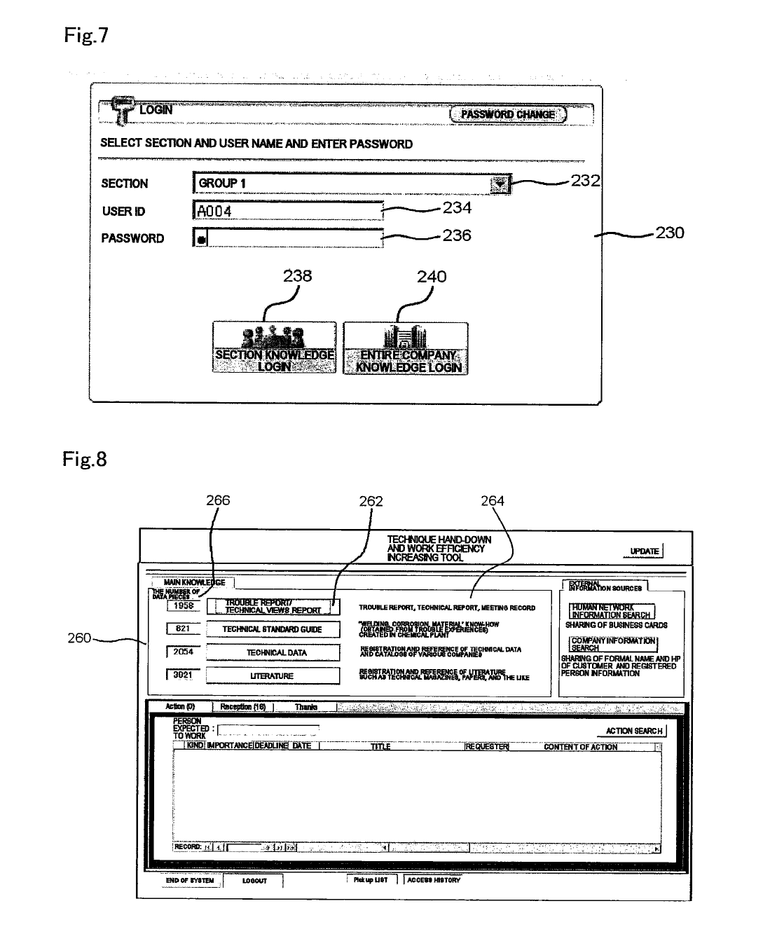

FIG. 7 is a diagram showing an example of a login screen 230 of the document management apparatus 100 of this embodiment. The login screen 230 includes a section name selection field 232, a user ID entry field 234, a password entry field 236, a section knowledge login button 238, and an entire company knowledge login button 240. In the section name selection field 232, for example, a list of a plurality of sections preliminarily registered is displayed, and selection of the user is accepted. In the user ID entry field 234, an entry of the user ID is accepted.

In the password entry field 236, an entry of a password is accepted. The sectional knowledge login button 238 accepts login to the section selected by the section name selection field 232, that is, an instruction of login to retrieve document information related to a specific section. The entire company knowledge login button 240 accepts an instruction of login to retrieve document information common to all of the sections regardless of the section name selection field 232. The information and the instruction selected, entered, operated, and accepted in the login screen 230 are accepted by the login accepting unit 104.

FIG. 8 is a diagram showing an example of a category selection screen 260 of the document management apparatus 100 of this embodiment. When the sectional knowledge login button 238 is operated in the login screen 230 of FIG. 7 and retrieval of document information related to a specific section is selected, the category selection screen 260 is displayed on the user terminal 1. In the category selection screen 260, selection of any of a plurality of categories, four categories in this case, provided for respective specific sections to which document information as a search target is related may be accepted. The category selected on the category selection screen 260 of FIG. 8 is accepted by the operation accepting unit 126.

The document management apparatus 100 has a search target accepting unit (the operation accepting unit 126) which accepts any of the plurality of categories which is selected, by a user, as a search target for searching document information related to the selected category. The document information storage unit 114 further stores information on the region in which the document is stored so as to be associated with the corresponding document information. The searching unit 132 narrows down to the region corresponding to the category of the search target accepted by the search target accepting unit (the operation accepting unit 126) and the section to which said user has been authorized, and searches within the narrowed region of the document information storage unit 114.

The category selection screen 260 includes a category selection button 262, a category explanation display field 264, and display fields 266 of the number of data pieces by categories. The category selection button 262 includes a plurality of buttons, in this case, four buttons by which a category may be selected from four categories “trouble report/technical views report”, “technical standard guide”, “technical data”, and “literature”. An example of a case where, for example, group 1 is selected will be taken here. The content of the category selection button 262 varies among the sections. In the category explanation display field 264, explanation of categories is shown to support the user so as to select an accurate category. In the display fields 266 of the number of data pieces by categories, the numbers of pieces of document information presently registered in the categories are displayed.

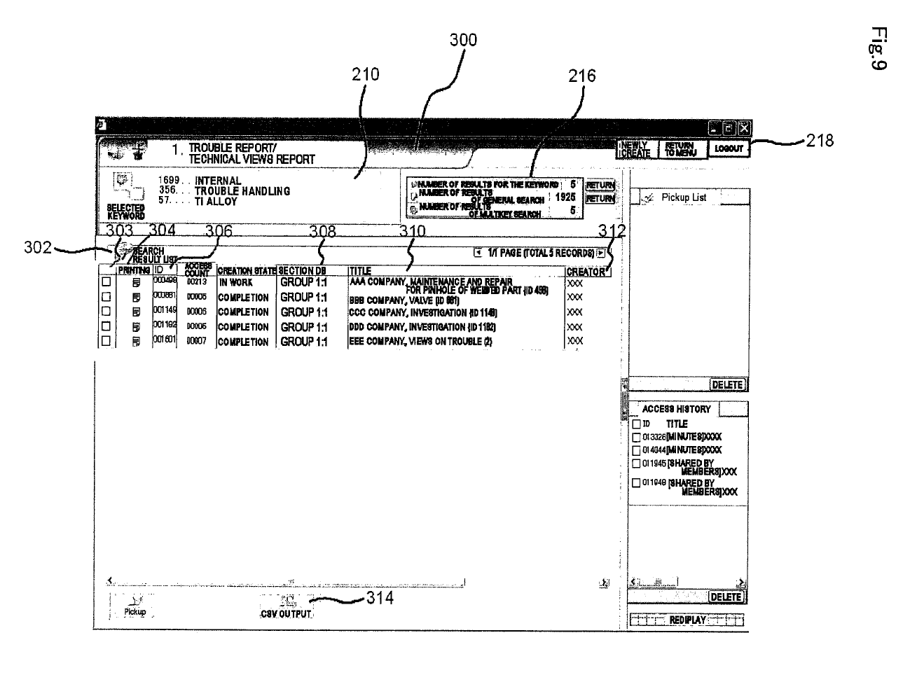

FIG. 9 is a diagram showing an example of a search result screen 300 of the document management apparatus 100 of this embodiment. The search result screen 300 is displayed when the search result display field 216 in FIG. 6 is selected. FIG. 9 shows an example when a keyword search result is selected. The search result screen 300 includes a search result list display field 302 and a data output button 314. In the search result list display field 302, the details of retrieved document information are displayed. The search result list display field 302 includes, for example, check boxes 303, print buttons 304, document ID fields 306, section and region fields 308, title fields 310, and creator fields 312.

When an operation on the data output button 314 is accepted, document information displayed in the search result list display field 302 may be output in, for example, a CSV format file. When an operation is accepted, the print button 304 can instruct a printer (not shown in the drawings) connected to the user terminal 1, the document management apparatus 100, or the network 3 to print and output the corresponding document information. In the document information ID field 306, the ID of document information is displayed. In the section and region field 308, the section and region in which document is stored are displayed. In the title field 310, the title of the document is displayed. In the creator field 312, the name of the creator of the document is displayed. The instruction selected, operated, and accepted on the search result screen 300 is accepted by the operation accepting unit 126. As described above, the search result and document information may be presented to the user not only by being displayed on the screen but also by data output, printing output, and the like.

FIG. 10 is a diagram showing an example of the document information screen 330 of the document management apparatus 100 of this embodiment. The document information screen 330 displays the details of selected document information when the document information ID field 306 is operated in the search result list display field 302 in the search result screen 300 of FIG. 9.

The document information screen 330 includes, for example, a title field 332, a creator field 334, a creation start date field 336, a final update date field 338, a content field 340, an attached file list 350, a related information list 360, and a print button 370. In the example of FIG. 10, the content field 340, the content of know-how information is displayed. In addition, for example, outline of document and the like may be also included.

As the attached file list 350, a list of information of document files corresponding to document information is displayed. The attached file list 350 includes, for example, document ID, document name, presence/absence of a user, attached file name, size of the file, remarks information, file registration date, name and section of a person who registered the information, update data, name and section of a person who updated the information, and the like.

As the related information list 360, a list of document information related to the document information is displayed. The related information list 360 includes, for example, document ID, section and region, title of document, name of creator, and the like. The print button 370 accepts an instruction of printing the document information. An instruction selected, operated, and accepted on the document information screen 330 is accepted by the operation accepting unit 126.

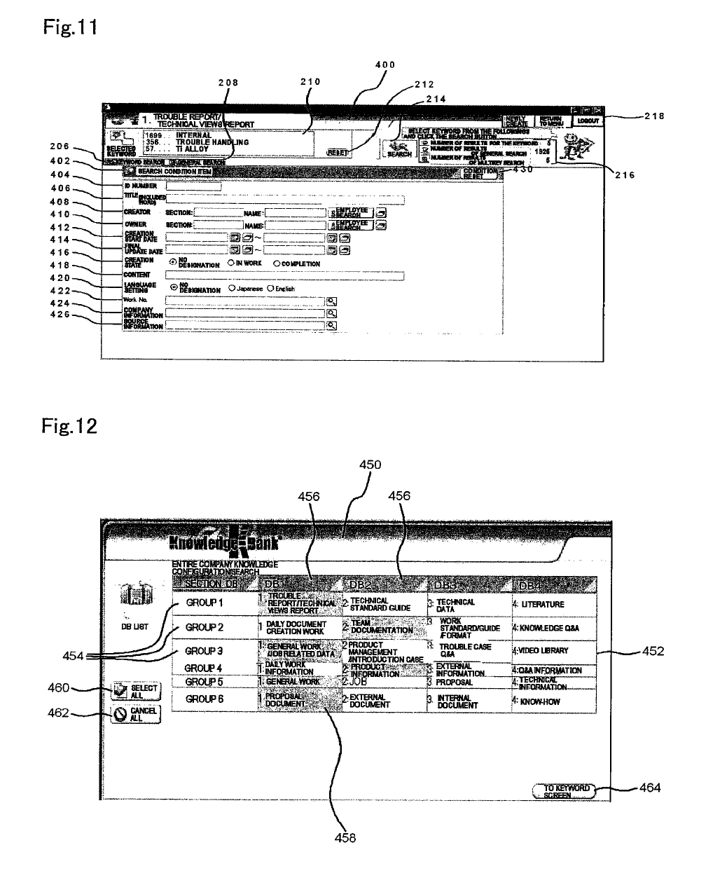

FIG. 11 is a diagram showing an example of a general search screen 400 of the document management apparatus 100 of this embodiment. When the general search tab 208 is selected, the general search screen 400 is displayed. The general search screen 400 includes a search condition item entry field 402 and a condition reset button 430.

The search condition item entry field 402 has various fields for entering items used for a general search. The search condition item entry field 402 includes, for example, an ID number field 404, a title field 406, a creator field 408, an owner field 410, a creation start date field 412, a final update date field 414, a creation state field 416, a content field 418, a language setting field 420, a work number field 422, a company information field 424, and a source information field 426. The condition reset button 430 accepts an instruction of resetting a condition entered in the search condition item entry field 402. Information and an instruction which is selected, entered, operated, and accepted in the general search screen 400 is accepted by the keyword accepting unit 130. The searching unit 132 in FIG. 1 searches the document information storage unit 114 in FIG. 1 under the condition entered in the search condition item entry field 402 in response to an operation on the search execution button 214. When selection of the search result display field 216 in the general search screen 400 is accepted, the presenting unit 128 in FIG. 1 displays the result of the search on the search result screen 300.

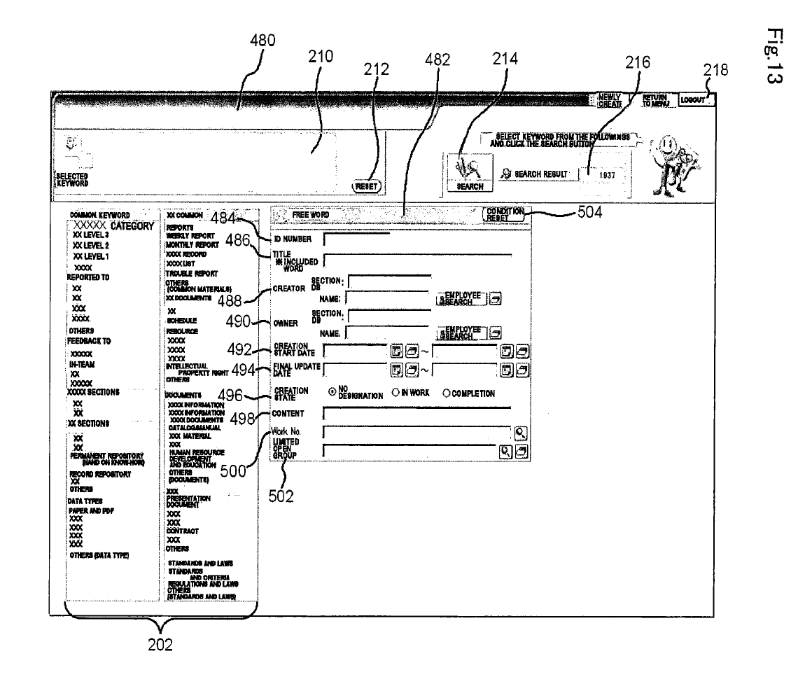

FIG. 12 is a diagram showing an example of a database selection screen 450 in the document management apparatus 100 of this embodiment. In a case where the entire company knowledge login button 240 is operated on the login screen 230 in FIG. 7 and a search of document information common to all of sections is selected, the database selection screen 450 is displayed on the user terminal 1. In the database selection screen 450, further, a matrix of a plurality of regions, in this case, four categories is displayed as a database list 452 every plurality of sections, in this case, every six sections. In the database selection screen 450, selection of any of the databases corresponding to document information to be retrieved may be accepted. If a user who logged in is in a group having no access right, the display may be changed not to accept selection, so that the user may recognize it.

In the document management apparatus 100 of FIG. 1, the authentication unit 108 in FIG. 1 accepts authentication of login to all of the plurality of sections and authorizes a user. The search target accepting unit (the operation accepting unit 126 in FIG. 1) accepts at least one of the plurality of sections which is selected as a search target for searching document information related to the selected section, and the searching unit 132 in FIG. 1 narrows down to the region corresponding to the section and the category as the search target accepted by the search target accepting unit (the operation accepting unit 126 in FIG. 1), and may search within the narrowed region of the document information storage unit 114 in FIG. 1.

The database selection screen 450 of FIG. 12 includes the database list 452, an all selection button 460, an all cancel button 462, and a keyword screen shift button 464.

The database list 452 is classified in a plurality of sections 454 and a plurality of regions 456. For example, the four categories of group 2 are “daily document creation work”, “team documentation”, “work standard, guide, and format”, and “knowledge questions and answers”. When the user logs in, the color of a region which is determined to have the access right by the determining unit 106 is changed. Regions having the access right may be selected as search targets. The all selection button 460 accepts an instruction of selecting all regions as regions for the search targets. The all cancel button 462 accepts an instruction of cancelling selection of the region once selected. In the database list 452, the selected region may be notified to the user by, for example, display in a different color, blinking display, check mark display, or the like.

After at least one region is selected on the database list 452, the keyword screen shift button 464 accepts an instruction to shift to the search screen. The instruction selected, operated, and accepted on the database selection screen 450 is accepted by the operation accepting unit 126.

FIG. 13 is a diagram showing an example of a keyword search screen 480 in the document management apparatus 100 of this embodiment. When the keyword screen shift button 464 of the database selection screen 450 of FIG. 12 is clicked, the screen shifts to the keyword search screen 480. The keyword search screen 480 includes, for example, the common keyword list display field 202, a free word entry field 482, and a condition reset button 504. On the keyword search screen 480, document information related to a plurality of sections selected on the database selection screen 450 of FIG. 12 can be retrieved. In this case, although the sectional keyword option list displayed on the sectional keyword list display field 204 of the keyword list display screen 200 is not used, document information by the common keyword option list and the free word can be retrieved.

The free word entry field 482 includes, for example, an ID number field 484, a title field 486, a creator field 488, an owner field 490, a creation start date field 492, a final update date field 494, a creation state field 496, a content field 498, a work number field 500, a limited disclosure group field 502, and the like.

The instruction operated and accepted on the keyword search screen 480 of FIG. 13 is accepted by the operation accepting unit 126. The keyword and the free word selected on the keyword search screen 480 are accepted by the keyword accepting unit 130 and notified to the searching unit 132. Using the keyword and the free word as a condition, the searching unit 132 retrieves corresponding document information from document information included in a region selected on the database selection screen 450 of FIG. 12. The number of search results is displayed in the search result display field 216 in FIG. 13. When selection of the search display field is accepted, the search result screen 300 of FIG. 9 is displayed.

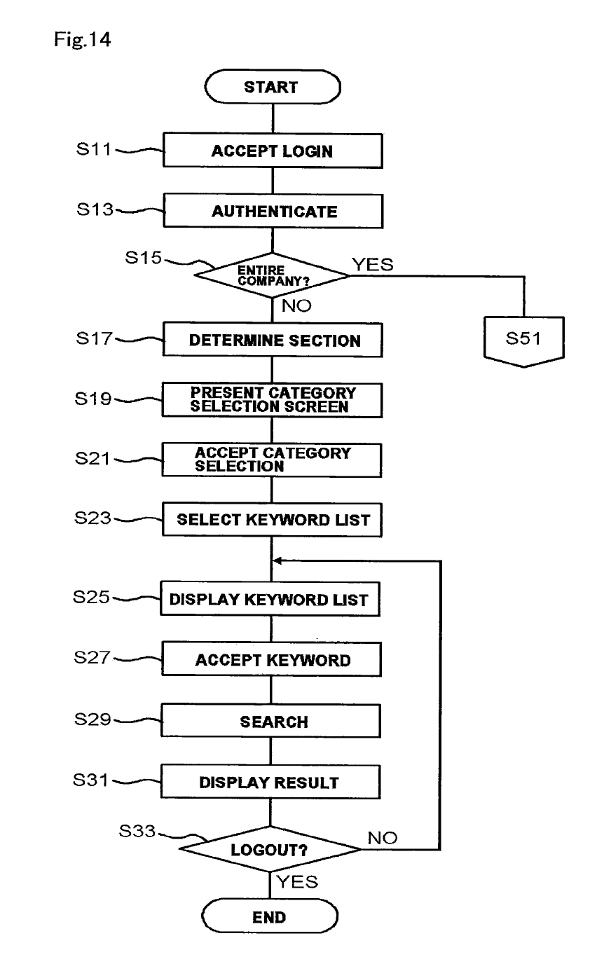

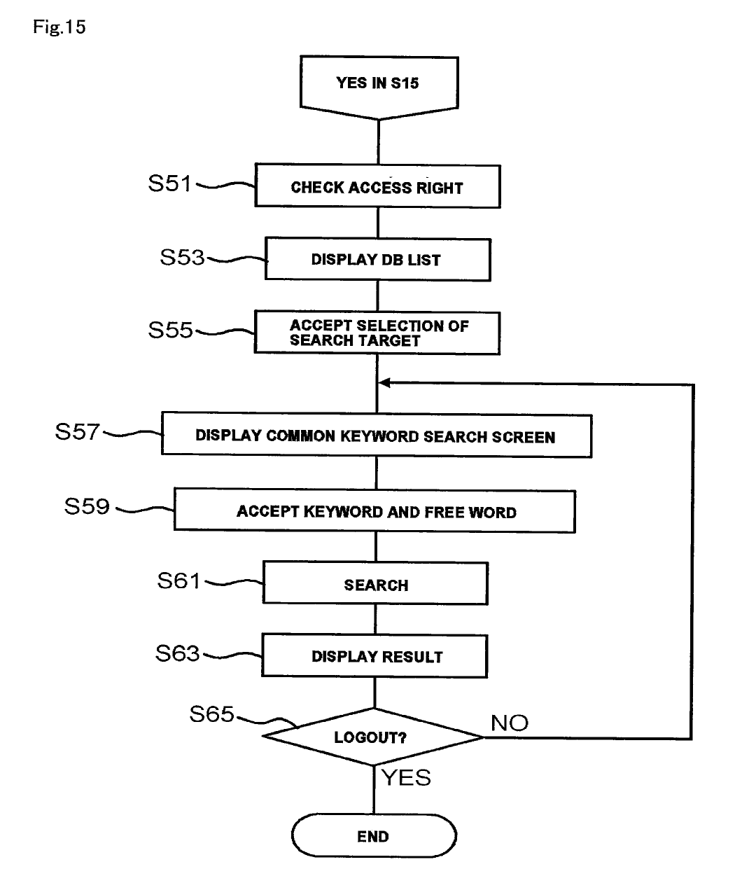

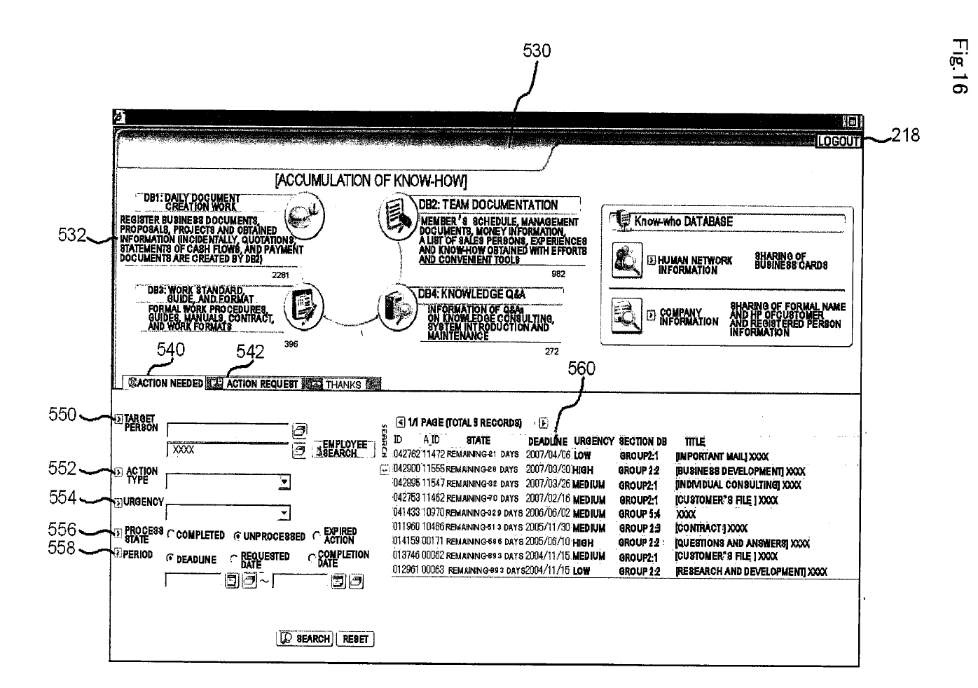

The operation of the document management apparatus 100 of this embodiment configured as described above will be described below. FIGS. 14 and 15 are flowcharts showing an example of the operation of the document management apparatus 100 of this embodiment. In the following, description will be given using FIGS. 1 to 15.

A document managing method according to the embodiment of the present invention is a method of electronically storing document information including at least one keyword associated with a document so as to search for the document into the document information storage unit 114 (FIG. 1) and managing it. The method includes: preparing a document information storage unit 114 (FIG. 1) which stores the document information; preparing a sectional keyword option storage unit (the sectional keyword list storage unit 122 in FIG. 1) which stores a plurality of sectional keyword option lists each containing a specialistic keyword relating to each of a plurality of sections; preparing a common keyword option storage unit (the common keyword list storage unit 120 in FIG. 1) which stores a common keyword option list containing a general keyword common to the plurality of sections; accepting selection of a section and entry of authentication information from a user (S11) and conducting login authentication to the section (S13); reading the sectional keyword option list corresponding to the authenticated section from the sectional keyword option storage unit (the sectional keyword list storage unit 122 in FIG. 1), reading the common keyword option list from the common keyword option storage unit (the common keyword list storage unit 120 in FIG. 1) (S23), and displaying the sectional keyword option list and the common keyword option list on a single screen (the keyword list display screen 200 in FIG. 6) (S25); accepting a keyword selected by the user from the sectional keyword option list or the common keyword option list displayed (S27);

searching the document information storage unit 114 (FIG. 1) based on the keyword accepted (S29); and presenting a result of the search to the user (S31).

Specifically, first, the login screen 230 in FIG. 7 is displayed to a user terminal 1 by the presenting unit 128 in FIG. 1. When the user operates the login screen 230 by using the operation unit, selects a section, enters his(her) user ID and his(her) password, and clicks the sectional knowledge login button 238 or the entire company knowledge login button 240 to give a login instruction, the login accepting unit 104 in FIG. 1 accepts the login instruction (S11). The authentication unit 108 authenticates the user (S13). Ina case where authentication fails, the screen returns again to the login screen 230 and displays a message to urge the user to re-enter his (her) user ID and his(her) password.

In a case where the user authentication succeeds, the determining unit 106 determines whether the entire company login is performed or not. That is, the determining unit 106 makes the determination depending on whether the sectional knowledge login button 238 is clicked or the entire knowledge login button 240 is clicked on the login screen 230. In a case where the login accepting unit 104 accepts the click on the entire company knowledge login button 240 (YES in S15), the step advances to step S51 which will be described later.

In a case where the login accepting unit 104 accepts the click of the sectional knowledge login button 238 (NO in S15), the determining unit 106 determines a section selected by the section name selection field 232 in the login screen 230 (S17). At this time, the determining unit 106 checks the access restriction of the section of the user who logged in and the section to be accessed with reference to the access right storage unit 112. In a case where there is no access right, a message of notifying of the fact is presented to the user, and the step returns to step S11, and may demand login again.

In a case where there is an access right, the screen selecting unit 124 is notified of the section to be accessed. The screen selecting unit 124 makes the presenting unit 128 present the category selection screen 260 of FIG. 8 prepared for each notified section (S19). The operation accepting unit 126 accepts click of the category selection button 262 selected on the category selection screen 260 in FIG. 8 (S21). The screen selecting unit 124 selects a sectional keyword option list corresponding to the section determined in step S17 from the sectional keyword list storage unit 122 (S23) and makes the presenting unit 128 present it in the sectional keyword list display field 204 in the keyword list display screen 200 of FIG. 6 (S25). At this time, the common keyword option list read from the common keyword list storage unit 120 is displayed in the common keyword list display field 202 in the keyword list display screen 200.

When the user selects keywords from the common keyword list display field 202 and the sectional keyword list display field 204 in the keyword list display screen 200, the keyword accepting unit 130 accepts the selected keywords (S27). When the operation accepting unit 126 accepts click of the search execution button 214 in the keyword list display screen 200, the searching unit 132 searches the document information storage unit 114 with the selected keywords (S29). The presenting unit 128 presents the number of results of the search made by the searching unit 132 in the search result display field 216 in FIG. 6 (S31). In such a manner, the search result as shown in the keyword list display screen 200 of FIG. 6 is displayed on the display unit of the user terminal 1. When the operation accepting unit 126 accepts a click on the logout button 218 in the keyword list display screen 200 in FIG. 6 (YES in S33), the process is finished.

Although detailed description will not be given, when the user selects the search result display field 216 with the operation unit in a state where the keyword list display screen 200 of FIG. 6 is displayed on the display unit in the user terminal 1, the search result screen 300 of FIG. 9 is displayed on the display unit in the user terminal 1. Further, when the user clicks a specific document ID in the document information ID field 306 in the search result list display field 302 on the search result screen 300 of FIG. 9 with a mouse or the like, the document information screen 330 of FIG. 10 is displayed on the display unit in the user terminal 1.

When the user clicks and selects the general search tab 208 with a mouse or the like using the operation unit in a state where the keyword list display screen 200 of FIG. 6 is displayed, the general search screen 400 of FIG. 11 is displayed on the display unit of the user terminal 1.

In a case where the login accepting unit 104 accepts the click of the sectional keyword list display field 204 in step S15 (YES in S15), the step advances to the procedures of FIG. 15. The determining unit 106 accesses the access right storage unit 112 to check an access right of the section of the user to the accepted section (S51). The screen selecting unit 124 makes the presenting unit 128 present the database selection screen 450 of FIG. 12 (S53). At this time, the color of the section and the region having the access right recognized in step S51 is changed in the access right display 458. In this case, it shows that the region DB1 of the group 1, the region DB2 of the group 2, the region DB1 of the group 3, and the like are accessible.

In the user terminal 1, when the user selects a region to be retrieved with the operation unit of the user terminal 1 in a state where the database selection screen 450 of FIG. 12 is displayed on the display unit, the operation accepting unit 126 accepts the selection (S55). In this case, a plurality of regions can be selected. When click on the keyword screen shift button 464 is accepted by the operation accepting unit 126, the screen selecting unit 124 makes the presenting unit 128 present the keyword search screen 480 of FIG. 13 (S57). In the user terminal 1, in a state where the keyword search screen 480 of FIG. 13 is displayed on the display unit, the user selects a keyword or enters a free word by using the operation unit of the user terminal 1. The keyword accepting unit 130 accepts the keyword and/or the free word selected and entered on the keyword search screen 480 in FIG. 13 (S59), and the searching unit 132 searches the document information storage unit 114 based on the keyword and the free word (S61).

The presenting unit 128 is allowed to present the search result on the keyword search screen 480 of FIG. 13 (S63). Consequently, the keyword search screen 480 of FIG. 13 is displayed on the display unit of the user terminal 1. When the operation accepting unit 126 accepts the selection of the search result 216 of the aforesaid keyword search screen, the search result screen 300 of FIG. 9 is displayed. When click on the logout button 218 is accepted by the operation accepting unit 126 (YES in S65), the process is finished.

In the document management apparatus 100 of this embodiment, the presenting unit 128 may also present a document management screen 530 shown in FIG. 16. The document management screen 530 includes a database explanation field 532, an “action needed” tab 540, an action request tab 542, and an action-needed document list 560.

In the database explanation field 532, explanation of a plurality of categories in the document management apparatus 100 of this embodiment is included. In a case where the “action-needed” tab 540 is selected, in an action-needed field, a target person field 550, an action type field 552, an urgency field 554, a process state field 556, and a period field 558 are displayed. When the action request tab 542 is selected, an action request screen is displayed, not shown in the drawings, and an action can be requested. In the action-needed document list 560, a list of documents to be subjected to an action of the target person selected in the target person field 550 is displayed.

As described above, information can be registered so as to be associated as document information with a work flow determined for each organization. By simultaneously performing the work and the document information registration, time and effort of registration may be omitted.

As described above, in the document management apparatus 100 according to the embodiment of the present invention, a keyword option list prepared for each section can be presented to a user who logged in the section, and allow the user to select a keyword. By providing the keyword option lists by sections, a document can be retrieved with a more appropriate keyword which is more specialistic and adapted to a section, so that a necessary document can be retrieved efficiently, and the document search efficiency improves. Consequently, effective utilization of document information accumulated is enabled. Since a search while designating a section can be performed, only document information related to a specific section can be also retrieved. For example, a search of a combination of the section “A” and a common keyword “spreadsheet” such as “data of a spreadsheet presented to the section A” can be made, so that usability improves. By making a setting so that the user registers data so as to be associated with at least one keyword and a keyword can be designated with reliability, the search efficiency can be improved. By using the screen for accepting designation of a keyword at the time of registration also as the screen for accepting designation of a keyword at the time of a search, both of efficiencies of designation of a keyword at the time of registration and search increase.

Originally, document information to be registered varies among organizations and works, and keywords for retrieving the document information also vary. In the document management apparatus 100 of the embodiment of the present invention, by logging in each of sections distinguished by organizations and works and providing a keyword option list for retrieving document information dedicated to the section, a number of pieces of unnecessary information (noise) of other sections can be prevented from being retrieved. In addition, by displaying a list of limited keywords, as compared with a case where the user freely chooses and registers keywords, a more appropriate keyword is given. Because of easiness of registration of document information, the designation ratio improves and, moreover, the document information retrieval efficiency also improves.

Since the user can appropriately set a search condition using limited keywords, usability is high, operability is excellent, an irrelevant search result due to erroneous selection of a keyword can be prevented. Thus, the search efficiency improves. In a case where the user of another section having no specialistic knowledge retrieves document information, a search can be performed using a general common keyword. Therefore, it is very convenient.

For example, in an entire-company knowledge login search, by selecting a section and a category of a search target using the database selection screen 450 of FIG. 12, conditions can be narrowed and a search can be made. Thus, unnecessary information (noise) can be reduced, and the document information search efficiency improves.

Although the embodiments of the present invention have been described above with reference to the drawings, they are examples of the present invention. It is apparent that the present invention is not limited to the above embodiment, and may be modified and changed without departing from the scope and spirit of the invention.

1. A document management apparatus comprising:
a document information storage unit which stores document information including at least one keyword associated with a document so as to search for the document;
a sectional keyword option storage unit which stores a plurality of sectional keyword option lists each containing a specialistic keyword relating to each of a plurality of sections;
a common keyword option storage unit which stores a common keyword option list containing a general keyword common to the plurality of sections;
an authentication unit which accepts selection of a section and entry of authentication information from a user and conducts login authentication to said section;
a keyword option list display unit which reads said sectional keyword option list corresponding to said section authenticated by said authentication unit from said sectional keyword option storage unit, reads said common keyword option list from said common keyword option storage unit, and displays said sectional keyword option list and said common keyword option list on a single screen;
an accepting unit which accepts a keyword selected by said user from said sectional keyword option list or said common keyword option list displayed on said keyword option list display unit;
a searching unit which searches said document information storage unit based on said keyword accepted by said accepting unit; and
a presenting unit which presents a result of said search made by said searching unit to said user.

2. The document management apparatus according to claim 1, further comprising:
a document storing unit, for the purpose of associating said document information with any of said plurality of sections and further classifying it to a plurality of categories, which has a plurality of regions corresponding to combinations of the sections and the categories and stores said document in any of the regions; and
a search target accepting unit which accepts any of said plurality of categories which is selected, by said user, as a search target for searching document information related to the selected category,
wherein said document information storage unit further stores information on the region in which said document is stored so as to be associated with the corresponding document information, and
said searching unit narrows down to said region corresponding to the category of the search target accepted by said search target accepting unit and said section to which said user has been authenticated, and searches within the narrowed region of said document information storage unit.

3. The document management apparatus according to claim 2, wherein said authentication unit accepts authentication of login to all of said plurality of sections and authenticates said user,
said search target accepting unit accepts at least one of said plurality of sections which is selected as a search target for searching document information related to the selected section, and
said searching unit narrows down to said region corresponding to the section and the category as the search target accepted by said search target accepting unit, and searches within the narrowed region of said document information storage unit.

4. The document management apparatus according to claim 1, further comprising:
a registration keyword option list display unit which displays said sectional keyword option list and said common keyword option list on a single screen in order to register a keyword associated as said document information of said document for the purpose of retrieving said document; and
a registration accepting unit which accepts, as a keyword which is included in document information to be associated with said document, a keyword selected by said user from said sectional keyword option list or said common keyword option list displayed on said keyword option list display unit,
wherein said accepted keyword is stored as said document information so as to be associated with said document in said document information storage unit.

5. A document managing method of electronically storing document information including at least one keyword associated with a document so as to search for said document into a document information storage unit and managing it, comprising:
preparing a document information storage unit which stores said document information;
preparing a sectional keyword option storage unit which stores a plurality of sectional keyword option lists each containing a specialistic keyword relating to each of a plurality of sections;
preparing a common keyword option storage unit which stores a common keyword option list containing a general keyword common to said plurality of sections;
accepting selection of a section and entry of authentication information from a user and conducting login authentication to said section;
reading said sectional keyword option list corresponding to the authenticated section from said sectional keyword option storage unit, reading said common keyword option list from said common keyword option storage unit, and displaying said sectional keyword option list and said common keyword option list on a single screen;
accepting a keyword selected by said user from said sectional keyword option list or said common keyword option list displayed;
searching said document information storage unit based on the accepted keyword; and
presenting a result of said search to said user.

6. A document management program stored on a computer readable medium for controlling a computer that electronically stores document information including at least one keyword associated with a document so as to search for said document into a document information database and manages it,
wherein said computer comprises:
a document information database in which said document information is stored;
a sectional keyword option storage unit which stores a plurality of sectional keyword option lists each containing a specialistic keyword relating to each of a plurality of sections; and
a common keyword option storage unit which stores a common keyword option list containing a general keyword common to said plurality of sections, and
said program stored on a computer readable medium makes said computer execute:
a procedure of accepting selection of a section and entry of authentication information from a user and conducting login authentication to said section;
a procedure of reading said sectional keyword option list corresponding to the authenticated section from said sectional keyword option storage unit, reading said common keyword option list from said common keyword option storage unit, and displaying said sectional keyword option list and said common keyword option list on a single screen;
a procedure of accepting a keyword selected by said user from said sectional keyword option list or said common keyword option list displayed;
a procedure of searching said document information database based on said keyword accepted; and
a procedure of presenting a result of said search to said user.
